(19) United States
(12) Patent Application Publication
(10) Pub. No.: US 2024/0344906 A1
(43) Pub. Date: Oct. 17, 2024

(54) ELECTRODE STRUCTURE

(71) Applicant: Panasonic Automotive Systems Co., Ltd., Kanagawa (JP)

(72) Inventors: Takumi YAMADA, Kyoto (JP); Takateru SAWADA, Osaka (JP); Hiroshi NAITOU, Osaka (JP)

(21) Appl. No.: 18/624,995

(22) Filed: Apr. 2, 2024

(30) Foreign Application Priority Data
Apr. 14, 2023 (JP) 2023-066610

(51) Int. Cl. G01L 1/14; B62D 1/06

(52) U.S. Cl. CPC G01L 1/142; B62D 1/06

(57) ABSTRACT

An electrode structure is an electrode structure that is wound around a rim of a steering wheel and includes: a base material including a first region disposed on a front surface side of the rim and a second region disposed on a back surface side of the rim; a first sensor electrode disposed in the first region; and a second sensor electrode disposed in the second region. When the steering wheel is in a neutral position, in a lower-limb facing portion of the rim that faces a lower limb of a driver, neither the first sensor electrode nor the second sensor electrode is disposed, or only one of the first sensor electrode or the second sensor electrode is disposed.

### CROSS REFERENCE TO RELATED APPLICATION

The present application is based on and claims priority of Japanese Patent Application No. 2023-066610 filed on Apr. 14, 2023.

### FIELD

The present disclosure relates to an electrode structure.

### BACKGROUND

Patent Literature (PTL) 1 discloses a sensor (electrode structure) that is disposed around the entire circumference of a steering wheel and detects the gripping by a driver and the like.

### CITATION LIST

### Patent Literature

PTL 1: Japanese Patent No. 5871422

### SUMMARY

However, the electrode structure according to PTL1 above can be improved upon.

In view of this, the present disclosure provides an electrode structure capable of improving upon the above related art.

An electrode structure according to one aspect of the present disclosure is an electrode structure to be wound around a rim of a steering wheel, the electrode structure including: a base material including a first region disposed on a front surface side of the rim and a second region disposed on a back surface side of the rim; a first sensor electrode disposed in the first region; and a second sensor electrode disposed in the second region. When the steering wheel is in a neutral position, in a lower-limb facing portion of the rim that faces a lower limb of a driver, neither the first sensor electrode nor the second sensor electrode is disposed, or only one of the first sensor electrode or the second sensor electrode is disposed.

The electrode structure according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a view illustrating an example of the use of an electrode structure according to an embodiment.

FIG. 2 is an explanatory view illustrating a state before the electrode structure according to the embodiment is installed onto the steering wheel.

FIG. 3 is a cross-sectional view of the steering wheel according to the embodiment.

FIG. 4 is a developed plan view illustrating an electrode structure according to Embodiment 1.

FIG. 5 is a perspective view illustrating the positional relationship between a first sensor electrode and a second sensor electrode in a state where electrode structure 10 according to Embodiment 1 is wound around the rim in the neutral position.

FIG. 6 is a developed plan view illustrating an electrode structure according to Embodiment 2.

FIG. 7 is a perspective view illustrating the positional relationship between a first sensor electrode and a second sensor electrode in a state where the electrode structure according to Embodiment 2 is wound around the rim in the neutral position.

FIG. 8 is a developed plan view illustrating an electrode structure according to Embodiment 3.

FIG. 9 is a developed plan view illustrating an electrode structure according to Embodiment 4.

FIG. 10 is a developed plan view illustrating an electrode structure according to Embodiment 5.

FIG. 11 is a developed plan view illustrating an electrode structure according to another example of Embodiment 5.

FIG. 12 is a developed plan view illustrating an electrode structure according to Embodiment 6.

FIG. 13 is a developed plan view illustrating an electrode structure according to another example of Embodiment 6.

FIG. 14 is a partial cross-sectional view of an electrode structure according to Embodiment 7.

FIG. 15 is a partial cross-sectional view of an electrode structure according to Embodiment 8.

### DESCRIPTION OF EMBODIMENTS

### (Underlying Knowledge Forming Basis of the Present Disclosure)

The present inventors have found that the following problems arise with the electrode structure described in the “Background” section. For example, in the electrode structure described above, there is a risk of erroneously detecting the contact of the driver's lower limb with the steering wheel as the driver gripping the wheel. That is, the present disclosure provides an electrode structure capable of preventing erroneous detection.

An electrode structure according to one aspect of the present disclosure is an electrode structure to be wound around a rim of a steering wheel, the electrode structure including: a base material including a first region disposed on a front surface side of the rim and a second region disposed on a back surface side of the rim; a first sensor electrode disposed in the first region; and a second sensor electrode disposed in the second region. When the steering wheel is in a neutral position, in a lower-limb facing portion of the rim that faces a lower limb of a driver, neither the first sensor electrode nor the second sensor electrode is disposed, or only one of the first sensor electrode or the second sensor electrode is disposed.

According to the above, since the first sensor electrode is disposed in the first region on the front surface side of the rim and the second sensor electrode is disposed in the second region on the back surface side of the rim, when the driver's hand comes into contact with both the first sensor electrode and the second sensor electrode, the contact can be detected as the driver gripping the rim (gripping detection). That is, since the gripping detection is not performed when the driver's hand comes into contact with only one of the first sensor electrode or the second sensor electrode, the accuracy of the gripping detection can be increased.

Furthermore, in the lower-limb facing portion, neither the first sensor electrode nor the second sensor electrode is disposed, or only one of the first sensor electrode or the second sensor electrode is disposed. Therefore, even when the driver's lower limb comes into contact with the lower-limb facing portion, the lower limb comes into contact with at most one of the first sensor electrode or the second sensor electrode. That is, erroneous detection caused by the contact of the lower limb can be prevented. Therefore, it is possible to provide an electrode structure capable of preventing erroneous detection.

The first sensor electrode may include a first notch formed in a part corresponding to the lower-limb facing portion, and a first protrusion adjacent to the first notch in a circumferential direction in an axial cross-section of the rim.

According to the above, it is possible to ensure a detection region with the first protrusion while forming an insensitive region with the first notch. Therefore, it is possible to prevent the insensitive region from becoming larger than necessary.

The electrode structure may include a first conductive layer overlaid on the protrusion.

According to the above, since the first conductive layer is overlaid on the first protrusion, the sensitivity can be increased by the first conductive layer. Thus, detection accuracy can be further increased.

The electrode structure may include a second conductive layer overlaid on the first conductive layer.

According to the above, since the second conductive layer is overlaid on the first conductive layer, the sensitivity can be increased by the second conductive layer. Thus, detection accuracy can be further increased.

The boundary between the first notch and the first protrusion may include an inclined portion.

According to the above, since the inclined portion is included in the boundary between the first notch and the first protrusion, it is possible to prevent a steep decrease in the first protrusion that is the detection region. Therefore, it is possible to reduce a decrease in sensitivity caused by the first notch.

The first sensor electrode and the second sensor electrode may be separated by a first length at a location corresponding to the lower-limb facing portion, and separated by a second length at a location corresponding to a portion other than the lower-limb facing portion, and the first length may be longer than the second length.

According to the above, since the first sensor electrode and the second sensor electrode are separated by the first length or the second length, interference between these electrodes can be reduced. Furthermore, since the first sensor electrode and the second sensor electrode are separated from each other by the first length, which is longer than the second length, at the location corresponding to the lower-limb facing portion, a large insensitive region can be ensured.

The second sensor electrode may include a second notch formed in a part corresponding to the lower-limb facing portion, and a second protrusion adjacent to the second notch in the circumferential direction in an axial cross-section of the rim.

According to the above, it is possible to ensure a detection region with the second protrusion while forming the insensitive region with the second notch. Therefore, it is possible to prevent the insensitive region from becoming larger than necessary.

The second sensor electrode may include an extension extending into the first notch.

According to the above, since the extension of the second sensor electrode extends into the first notch of the first sensor electrode, the lower-limb facing portion is mainly covered with the second sensor electrode. As a result, even when the driver's lower limb comes into contact with the lower-limb facing portion, the lower limb comes into contact only with the second sensor electrode. That is, erroneous detection caused by the contact of the lower limb can be prevented.

At the time of winding the base material around the rim, the state of being stretched varies depending on whether the sensor electrode is present or absent. However, the variation can be reduced due to the extension being disposed within the first notch, thereby reducing the unevenness of the winding.

The base material may be wound around the rim so that both ends of the base material are adjacent to each other in the lower-limb facing portion.

According to the above, since both ends of the base material are adjacent to each other in the lower-limb facing portion, the boundary between both ends of the base material can be made less noticeable when the steering wheel is in the neutral position.

The first sensor electrode and the second sensor electrode may each include a conductive sheet that increases in resistivity when stretched.

According to the above, it is possible to reduce a change in sensor sensitivity due to a difference in gripping position between the lower-limb facing portion and the other part.

### EMBODIMENTS

Exemplary embodiments of the present invention will be described in detail below with reference to the drawings. Note that each of the embodiments described below is a specific example of the present disclosure. Numerical values, shapes, materials, components, arrangement positions of components, connection modes, and the like shown in the following embodiments are examples, and are not intended to limit the present disclosure. In addition, among the components in the following embodiments, components that are not described in the independent claim showing the broadest concept are described as optional components.

### (Example of Use of Electrode Structure)

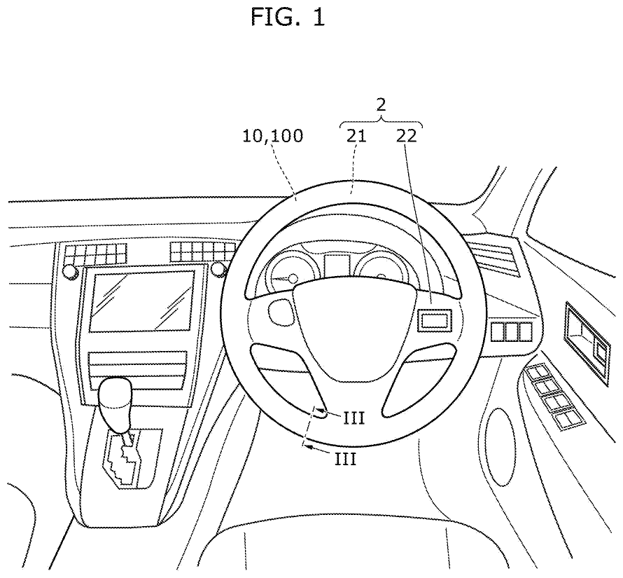

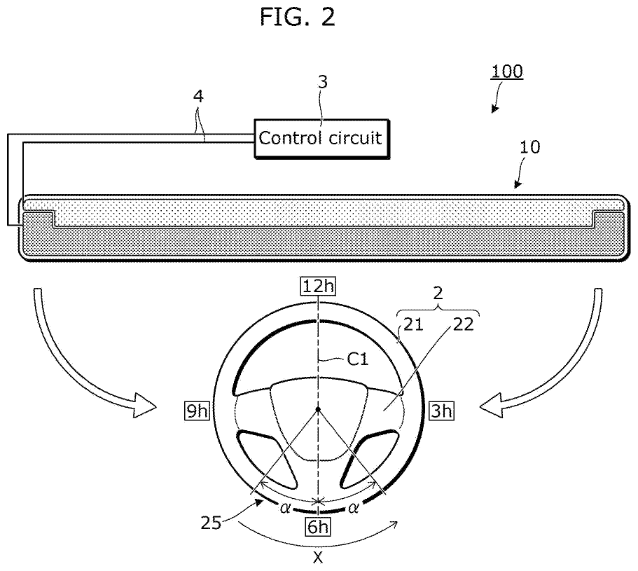

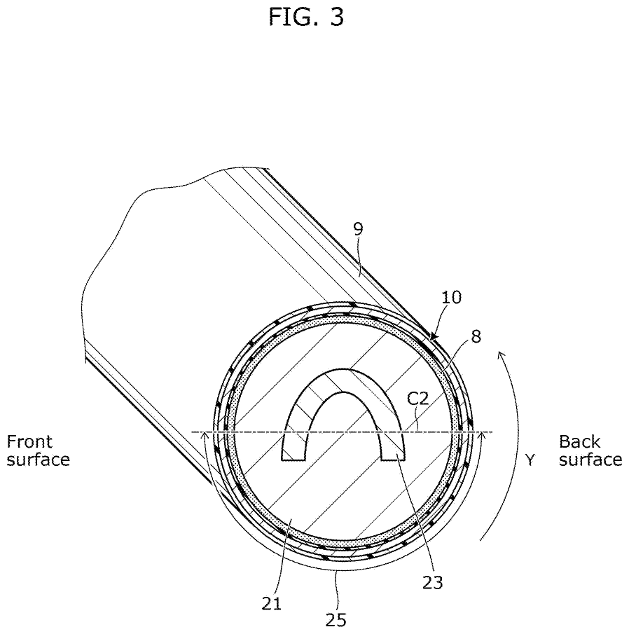

First, an example of the use of electrode structure 10 according to the present embodiment will be described with reference to FIGS. 1 to 3. FIG. 1 is a view illustrating an example of the use of electrode structure 10 according to the embodiment. FIG. 2 is an explanatory view illustrating a state before electrode structure 10 according to the embodiment is installed onto steering wheel 2. FIG. 3 is a cross-sectional view of steering wheel 2 according to the embodiment. FIG. 3 illustrates an axial cross-section of rim 21 of steering wheel 2, and specifically, FIG. 3 is a cross-sectional view taken along line III-III in FIG. 1. FIG. 2 illustrates positions on a clock when steering wheel 2 is in the neutral position, with 3 o'clock, 6 o'clock, 9 o'clock, and 12 o'clock positions denoted as “3h”, “6h”, “9h”, and “12h”, respectively. This illustration also applies to the subsequent figures.

FIG. 3 illustrates the front surface side of rim 21 as a “front surface”, and the back surface side thereof as a “back surface”. The front surface side of rim 21 is the half region facing a driver when rim 21 is viewed laterally, and the back surface side of rim 21 is the half region facing away from the driver when rim 21 is viewed laterally.

Electrode structure 10 in the present embodiment is configured as a part of in-vehicle grip sensor 100 and is provided, for example, on steering wheel 2 of vehicle 1. Electrode structure 10 is a capacitive sensor electrode (hereinafter also referred to as a sensor unit) that detects the gripping of steering wheel 2 by the driver's hand.

Here, steering wheel 2 includes rim 21 and substantially T-shaped spoke 22 formed integrally with the inner circumferential surface of rim 21, and electrode structure 10 is wound around rim 21. Specifically, as illustrated in FIG. 2, electrode structure 10 is wound around rim 21 so that the longitudinal center of electrode structure 10 is located at the upper end of rim 21 (12 o'clock position). Thus, both longitudinal ends of electrode structure 10 are disposed to be adjacent to each other at the lower end of rim 21 (6 o'clock position). While including electrode structure 10 as the sensor unit, grip sensor 100 also includes control circuit 3 and a plurality of harnesses 4. Control circuit 3 detects the gripping of rim 21 by the driver based on a signal from electrode structure 10, and harnesses 4 electrically connect control circuit 3 and electrode structure 10.

As illustrated in FIG. 3, rim 21 is a portion where a shaft, circular in the axial cross-section, is formed in an annular shape in plan view. Rim 21 includes internal metal core 23 that forms the core material of rim 21. Electrode structure 10 covers the entire circumference of rim 21 through adhesive layer 8 in the axial cross-section. Cover body 9, made of urethane or leather, is provided on the outer circumferential surface of electrode structure 10.

In electrode structure 10, the capacitance changes according to whether or not the driver of vehicle 1 is gripping rim 21 of steering wheel 2. Specifically, electrode structure 10 outputs a signal to control circuit 3 indicating a change in capacitance between the driver's hand and electrode structure 10. Based on this signal, control circuit 3 detects whether or not the driver's hand is in contact with rim 21 (strictly speaking, the surface of cover body 9).

FIG. 2 illustrates a case where steering wheel 2 is in the neutral position is illustrated, and in this state, the lower end of rim 21 falls in lower-limb facing portion 25 that faces the lower limb of the seated driver. When steering wheel 2 is viewed in plan view, lower-limb facing portion 25 is a range that lies within angle α on each of the left and right sides with respect to center line C1 along the vertical direction. Angle α is preferably 5 degrees or more and 45 degrees or less, and more preferably 15 degrees or more and 30 degrees or less. Furthermore, as illustrated in FIG. 3, rim 21 does not face the driver's lower limb above center line C2 in the axial view, but faces the driver's lower limb below center line C2. Center line C2 is based on a circle with the center of rim 21 as a reference when rim 21 is viewed in plan view. Center line C2 can be said to be a line connecting the vertex on the front surface side and the vertex on the back surface side of rim 21 when viewed in cross-section. That is, lower-limb facing portion 25 is a region positioned below center line C2 in cross-section within the above range of rim 21.

### Embodiment 1

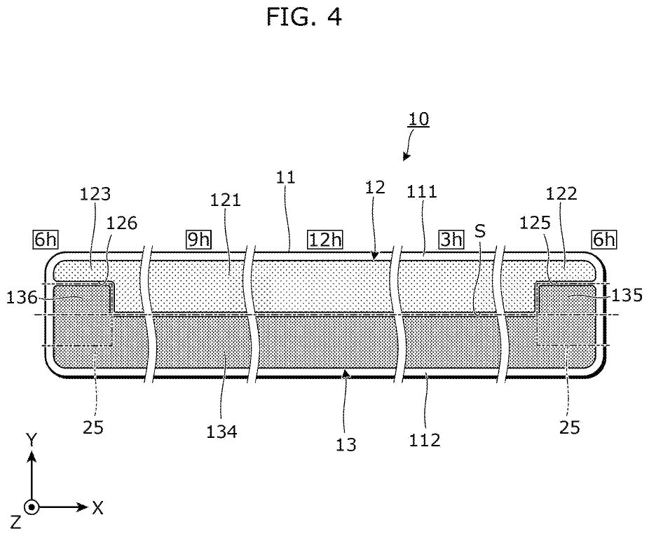

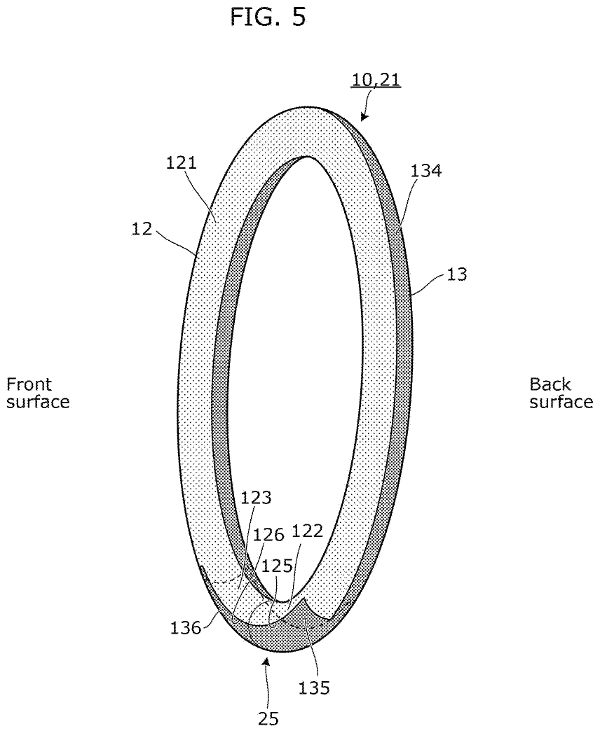

Next, the configuration of electrode structure 10 according to Embodiment 1 will be described. FIG. 4 is a developed plan view illustrating electrode structure 10 according to Embodiment 1. FIG. 5 is a perspective view illustrating the positional relationship between first sensor electrode 12 and second sensor electrode 13 in a state where electrode structure 10 according to Embodiment 1 is wound around rim 21 in the neutral position.

In FIG. 4, the longitudinal direction of electrode structure 10 is the X-axis direction, the width direction of electrode structure 10 is the Y-axis direction, and the thickness direction of electrode structure 10 is the Z-axis direction. The X-axis direction corresponds to the circumferential direction when steering wheel 2 is viewed in plan view (see FIG. 2), and the Y-axis direction corresponds to the circumferential direction when steering wheel 2 is viewed in the axial direction (see FIG. 3). FIG. 4 illustrates the main surface of electrode structure 10, which is the front side when electrode structure 10 is wound around rim 21. In FIG. 4, the outer shape of lower-limb facing portion 25 is indicated by a two-dot-dash line. Since FIG. 4 is a developed view of electrode structure 10, lower-limb facing portion 25 is divided into two in the X-axis direction. In FIGS. 4 and 5, first sensor electrode 12 is indicated by light dot hatching, and second sensor electrode 13 is indicated by dark dot hatching. First sensor electrode 12 and second sensor electrode 13 are arranged with gap S therebetween. Gap S has a uniform line width over the entire length.

As illustrated in FIG. 4, electrode structure 10 includes base material 11, first sensor electrode 12, and second sensor electrode 13. Base material 11 is a sheet body elongated in the X-axis direction. Specifically, base material 11 is an insulating member formed of an elastic, flexible, and ductile material. Base material 11 is a foam material made of a synthetic resin such as polyethylene (PE), polyethylene terephthalate (PET), or polyurethane (PU). Base material 11 is formed according to the shape and size of rim 21. Note that base material 11 is not limited to a ductile material, and for example, a non-woven fabric with low ductility may be used.

Here, in base material 11, a region in the Y-axis plus direction from the center in the Y-axis direction is first region 111 disposed on the front surface side of rim 21. On the other hand, in base material 11, a region extending in the Y-axis minus direction from the center in the Y-axis direction is second region 112 disposed on the back surface side of rim 21. In FIG. 4, the boundary between first region 111 and second region 112 is indicated by a dash-dotted line. As described above, both ends of electrode structure 10 in the longitudinal direction (X-axis direction) are arranged to be adjacent to each other at the lower end of rim 21 (6 o'clock position). That is, base material 11 is wound around rim 21 so that both longitudinal ends of base material 11 are adjacent to each other in lower-limb facing portion 25. In the wound state, the back-side main surface of base material 11 is overlaid on adhesive layer 8 on rim 21.

First sensor electrode 12 is a conductive layer disposed in first region 111. Specifically, first sensor electrode 12 is entirely contained within first region 111. First sensor electrode 12 integrally includes first portion 121, second portion 122, and third portion 123.

First portion 121 is a rectangular portion in plan view formed within a part not facing lower-limb facing portion 25 in first region 111. First portion 121 covers substantially the entire part not facing lower-limb facing portion 25.

Second portion 122 is a rectangular portion in plan view protruding in the X-axis plus direction from the end of first portion 121 in the X-axis plus direction. Second portion 122 is an example of a first protrusion. Second portion 122 protrudes from the half region of first portion 121 in the Y-axis plus direction. Thus, the end of first sensor electrode 12 in the X-axis plus direction is provided with rectangular notch 125 in plan view formed in a part corresponding to lower-limb facing portion 25. Notch 125 is an example of a first notch adjacent to second portion 122 in the Y-axis direction. Note that the width of second portion 122 in the Y-axis direction may be equal to or more than, or may be less than, half of the width of first portion 121 in the Y-axis direction, as long as second portion 122 does not face the lower limb.

Third portion 123 is a rectangular portion in plan view protruding in the X-axis minus direction from the end of first portion 121 in the X-axis minus direction. Third portion 123 is an example of the first protrusion. Third portion 123 protrudes from the half region of first portion 121 in the Y-axis plus direction. Thus, the end of first sensor electrode 12 in the X-axis minus direction is provided with rectangular notch 126 in plan view formed in a part corresponding to lower-limb facing portion 25. Notch 126 is an example of a first notch adjacent to third portion 123 in the Y-axis direction. Due to the provision of each of notches 125, 126, first sensor electrode 12 is not disposed in lower-limb facing portion 25. Note that the width of third portion 123 in the Y-axis direction may be equal to or more than, or may be less than, half of the width of first portion 121 in the Y-axis direction, as long as third portion 123 does not face the lower limb.

Second sensor electrode 13 is a conductive layer disposed in second region 112. Similarly to first sensor electrode 12, this conductive layer is also formed by, for example, attaching a sheet with conductivity to base material 11. Specifically, second sensor electrode 13 is mainly disposed in second region 112 and partially disposed in first region 111. Second sensor electrode 13 integrally includes fourth portion 134, fifth portion 135, and sixth portion 136.

Fourth portion 134 is a rectangular portion in plan view formed over the entire second region 112.

Fifth portion 135 is a rectangular portion in plan view protruding in the Y-axis plus direction from the end of fourth portion 134 in the X-axis plus direction, and extending into notch 125. Fifth portion 135 is an example of an extension. Fifth portion 135 entirely covers first region 111 exposed by notch 125.

Sixth portion 136 is a rectangular portion in plan view protruding in the Y-axis plus direction from the end of fourth portion 134 in the X-axis minus direction, and extending into notch 126. Sixth portion 136 is an example of the extension. Sixth portion 136 entirely covers first region 111 exposed by notch 126.

As described above, in lower-limb facing portion 25, fifth portion 135 and sixth portion 136 of second sensor electrode 13 are disposed, and first sensor electrode 12 is not disposed. Thus, as illustrated in FIG. 5, when rim 21 is in the neutral position, only second sensor electrode 13 is disposed in lower-limb facing portion 25.

Here, the conductive layer that constitutes each of first sensor electrode 12 and second sensor electrode 13 will be described. The conductive layer is formed by, for example, attaching a sheet with conductivity (conductive sheet) to base material 11. In particular, as the conductive layer, a ductile conductive sheet that increases in resistivity when stretched is used. Examples of the conductive sheet include a conductive rubber sheet that becomes thinner and increases in resistivity when stretched. The reason for using such a conductive layer is as follows.

As described with reference to FIG. 2, electrode structure 10 is wound around rim 21. At this time, the center line part (gap S part) of electrode structure 10 in the X-axis direction in FIG. 4 is wound around the outermost circumference of rim 21 when viewed from the front. Hence, electrode structure 10 is wound around rim 21 in a state where the center line part is stretched. As a result, the conductive layer of each of first sensor electrode 12 and second sensor electrode 13 disposed near the center line part is stretched together with base material 11, thereby increasing the resistivity. On the other hand, the conductive layer at the end of base material 11, apart from the center line part in the Y-axis direction, is wound around rim 21 almost without being stretched, thereby hardly increasing the resistivity. Therefore, with the conductive layer wound around rim 21, the resistivity of the conductive layer near the outermost circumference of rim 21 is higher, and the resistivity of the conductive layer wound around the vicinity of the inner circumference of rim 21 (the end of base material 11 in the plus direction of the Y-axis and the end of base material 11 in the minus direction of the Y-axis in FIG. 4) is lower than the resistivity near the outermost circumference.

Next, for example, in FIG. 4, when the driver grips the 3h part of steering wheel 2, and when first sensor electrode 12 is focused on, the driver's palm faces a portion of the conductive layer, which constitutes first sensor electrode 12, extending from the center line part toward the end of base material 11 in the Y-axis plus direction. At this time, the resistivity is higher at the center line part and lower at the end of base material 11 in the Y-axis plus direction, and hence, the sensitivity of first sensor electrode 12 is dominant at the end of base material 11 in the Y-axis plus direction.

On the other hand, in FIG. 4, when the driver grips the part of steering wheel 2 corresponding to 5h, and when first sensor electrode 12 is focused on, the driver's palm faces only the first protrusion (second portion 122). At this time, the sensitivity of first sensor electrode 12 is dominant at the first protrusion with lower resistivity, that is, the end of base material 11 in the Y-axis plus direction.

From these facts, the sensitivity at the end of base material 11 in the Y-axis plus direction dominantly influences the sensitivity of first sensor electrode 12, regardless of whether the 3h or 5h part is gripped, and the sensitivity at the center line part is relatively minor. Therefore, by using the conductive layer described above, it is possible to reduce a change in sensor sensitivity due to a difference in the gripping position between the first protrusion (second portion 122 and third portion 123) and the other part (first portion 121), thereby increasing the detection accuracy.

### (Effects, etc.)

As described above, the electrode structure according to the present disclosure is electrode structure 10 that is wound around rim 21 of steering wheel 2 and includes: base material 11 including first region 111 disposed on the front surface side of rim 21 and second region 112 disposed on the back surface side of rim 21, first sensor electrode 12 disposed in first region 111, and second sensor electrode 13 disposed in second region 112. When steering wheel 2 is in the neutral position, in lower-limb facing portion 25 of rim 21 that faces the lower limb of a driver, only second sensor electrode 13 is disposed.

According to the above, since first sensor electrode 12 is disposed in first region 111 on the front surface side of rim 21 and second sensor electrode 13 is disposed in second region 112 on the back surface side of rim 21, when the driver's hand comes into contact with both first sensor electrode 12 and second sensor electrode 13, the contact can be detected as the driver gripping the rim (gripping detection). That is, since the gripping detection is not performed when the driver's hand comes into contact with only one of first sensor electrode 12 or second sensor electrode 13, the accuracy of the gripping detection can be increased.

Furthermore, only second sensor electrode 13 is disposed in lower-limb facing portion 25. Thus, even when the driver's lower limb comes into contact with lower-limb facing portion 25, the lower limb comes into contact with at most one of first sensor electrode 12 or second sensor electrode 13. That is, erroneous detection caused by the contact of the lower limb can be prevented. Therefore, it is possible to provide electrode structure 10 capable of preventing erroneous detection.

First sensor electrode 12 includes a first notch (notches 125, 126) formed in a part corresponding to lower-limb facing portion 25, and a first protrusion (second portion 122 and third portion 123) adjacent to notches 125, 126 in the circumferential direction in the axial cross-section of rim 21.

According to the above, it is possible to ensure a detection region with the first protrusion while forming an insensitive region with the first notch. Therefore, it is possible to prevent the insensitive region from becoming larger than necessary.

Second sensor electrode 13 may include an extension (fifth portion 135 and sixth portion 136) extending into the first notch.

According to the above, since the extension of second sensor electrode 13 extends into the first notch of first sensor electrode 12, lower-limb facing portion 25 is covered with second sensor electrode 13. As a result, even when the driver's lower limb comes into contact with lower-limb facing portion 25, the lower limb comes into contact only with second sensor electrode 13. That is, erroneous detection caused by the contact of the lower limb can be prevented.

At the time of winding base material 11 around rim 21, the stretched state varies depending on whether the sensor electrode (first sensor electrode 12 and second sensor electrode 13) is present or absent. However, the variation can be reduced because the extension is disposed within the first notch, thereby reducing the unevenness of the winding.

Base material 11 is wound around rim 21 so that both ends of base material 11 are adjacent to each other in lower-limb facing portion 25.

According to the above, since both ends of base material 11 are adjacent to each other in lower-limb facing portion 25, the boundary between both ends of base material 11 can be made less noticeable when steering wheel 2 is in the neutral position.

First sensor electrode 12 and second sensor electrode 13 are each made of a conductive sheet that increases in resistivity when stretched.

According to the above, it is possible to reduce a change in sensor sensitivity due to a difference in gripping position between lower-limb facing portion 25 and the other part.

### Embodiment 2

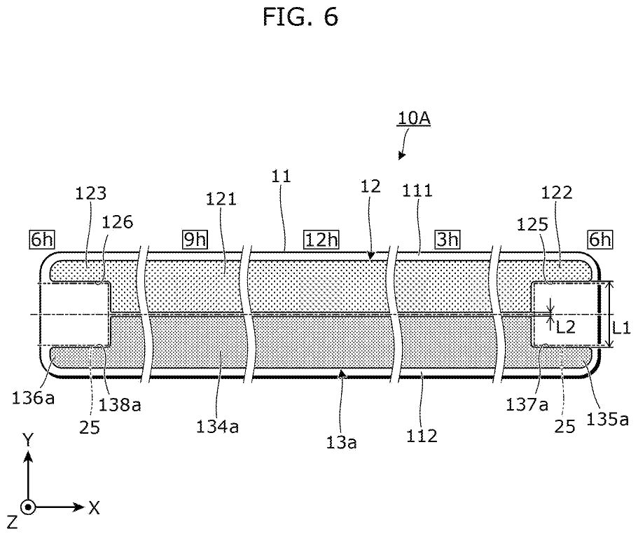

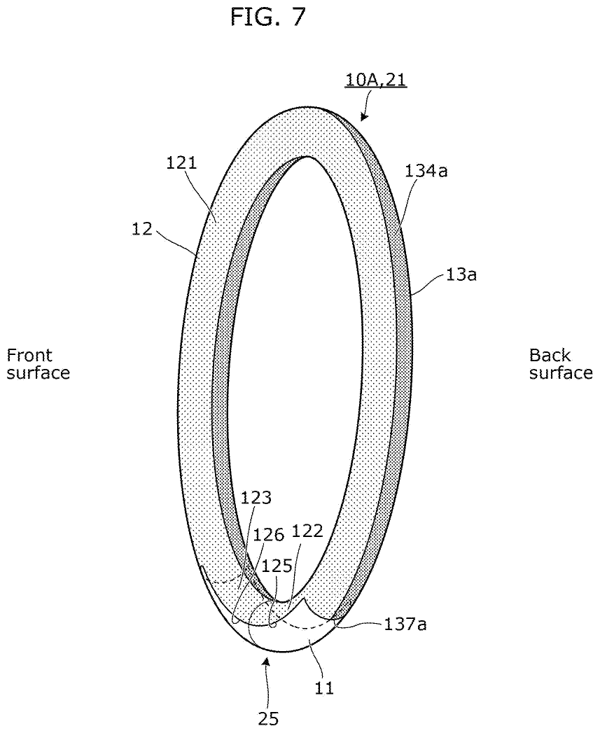

Next, electrode structure 10A according to Embodiment 2 will be described. FIG. 6 is a developed plan view illustrating electrode structure 10A according to Embodiment 2. FIG. 7 is a perspective view illustrating the positional relationship between first sensor electrode 12 and second sensor electrode 13a in a state where electrode structure 10A according to Embodiment 2 is wound around rim 21 in the neutral position. FIG. 6 is a view corresponding to FIG. 4, and FIG. 7 is a view corresponding to FIG. 5.

As illustrated in FIG. 6, in electrode structure 10A according to Embodiment 2, second sensor electrode 13a is different from second sensor electrode 13 according to Embodiment 1. In the following description, parts equivalent to those in Embodiment 1 are denoted by the same reference numerals, and the description thereof may be omitted.

Specifically, second sensor electrode 13a is entirely contained within second region 112. Second sensor electrode 13a integrally includes fourth portion 134a, fifth portion 135a, and sixth portion 136a.

Fourth portion 134a is a rectangular portion in plan view formed in a part not facing lower-limb facing portion 25 within second region 112. Fourth portion 134a covers substantially the entire part not facing lower-limb facing portion 25.

Fifth portion 135a is a rectangular portion in plan view protruding in the X-axis plus direction from the end of fourth portion 134a in the X-axis plus direction. Fifth portion 135a is an example of a second protrusion. Fifth portion 135a protrudes from the half region of fourth portion 134a in the Y-axis minus direction. Thus, the end of second sensor electrode 13a in the X-axis plus direction is provided with rectangular notch 137a in plan view formed in a part corresponding to lower-limb facing portion 25. Notch 137a is an example of a second notch adjacent to fifth portion 135a in the Y-axis direction. Note that the width of fifth portion 135a in the Y-axis direction may be equal to or more than, or may be less than, half of the width of fourth portion 134a in the Y-axis direction, as long as fifth portion 135a does not face the lower limb.

Sixth portion 136a is a rectangular portion in plan view protruding in the X-axis minus direction from the end of fourth portion 134a in the X-axis minus direction. Sixth portion 136a is an example of the second protrusion. Sixth portion 136a protrudes from the half region of fourth portion 134a in the Y-axis minus direction. Thus, the end of second sensor electrode 13a in the X-axis minus direction is provided with rectangular notch 138a in plan view formed in a part corresponding to lower-limb facing portion 25. Notch 138a is an example of a second notch adjacent to sixth portion 136a in the Y-axis direction. Note that the width of sixth portion 136a in the Y-axis direction may be equal to or more than, or may be less than, half of the width of fourth portion 134a in the Y-axis direction, as long as sixth portion 136a does not face the lower limb.

Due to the provision of each of notches 137a, 138a, second sensor electrode 13a is not disposed in lower-limb facing portion 25 (see FIG. 7). That is, in Embodiment 2, both first sensor electrode 12 and second sensor electrode 13a are not disposed in lower-limb facing portion 25, and base material 11 is exposed. Therefore, even when the driver's lower limb comes into contact with lower-limb facing portion 25, the lower limb comes into contact with at most one of first sensor electrode 12 or second sensor electrode 13a. That is, erroneous detection caused by the contact of the lower limb can be prevented.

First sensor electrode 12 and second sensor electrode 13a are separated by first length L1 at a location corresponding to lower-limb facing portion 25, and separated by second length L2 at a location corresponding to a portion other than lower-limb facing portion 25. First length L1 is longer than second length L2.

Since first sensor electrode 12 and second sensor electrode 13a are separated by first length L1 or second length L2 as described above, the interference therebetween can be reduced. Furthermore, since first sensor electrode 12 and second sensor electrode 13a are separated from each other by first length L1, which is longer than second length L2, at the location corresponding to lower-limb facing portion 25, a large insensitive region can be ensured.

Second sensor electrode 13a includes a second notch (notches 137a, 138a) formed in a part corresponding to lower-limb facing portion 25, and a second protrusion (fifth portion 135a and sixth portion 136a) adjacent to the second notch in the circumferential direction in the axial cross-section of rim 21.

According to the above, it is possible to ensure a detection region with the second protrusion while forming the insensitive region with the second notch. Therefore, it is possible to prevent the insensitive region from becoming larger than necessary.

### Embodiment 3

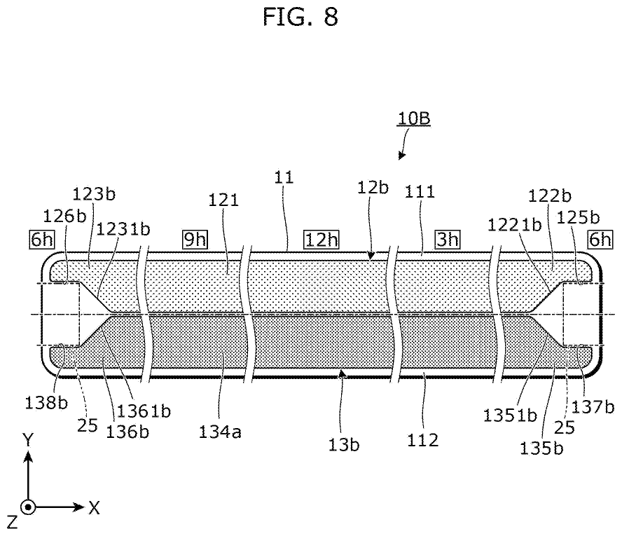

Next, electrode structure 10B according to Embodiment 3 will be described. FIG. 8 is a developed plan view illustrating electrode structure 10B according to Embodiment 3. FIG. 8 is a diagram corresponding to FIG. 6.

As illustrated in FIG. 8, in electrode structure 10B according to Embodiment 3, first sensor electrode 12b and second sensor electrode 13b are different from first sensor electrode 12 and second sensor electrode 13a according to Embodiment 2. In the following description, parts equivalent to those in Embodiments 1 and 2 are denoted by the same reference numerals, and the description thereof may be omitted.

Second portion 122b and third portion 123b of first sensor electrode 12b each have a tapered shape. Specifically, second portion 122b includes a part parallel to the X-axis direction, and a part (inclined portion 1221b) inclined with respect to the X-axis direction to be tapered in the Y-axis plus direction toward the X-axis plus direction. The tip of second portion 122b is formed in a rectangular shape in plan view. As described above, the boundary between notch 125b and second portion 122b includes inclined portion 1221b. Similarly, third portion 123b includes a part parallel to the X-axis direction, and a part (inclined portion 1231b) inclined with respect to the X-axis direction to be tapered in the Y-axis plus direction toward the X-axis minus direction. The tip of third portion 123b is formed in a rectangular shape in plan view. As described above, the boundary between notch 126b and third portion 123b includes inclined portion 1231b.

Fifth portion 135b and sixth portion 136b of second sensor electrode 13b are tapered. Specifically, fifth portion 135b includes a part parallel to the X-axis direction, and a part (inclined portion 1351b) inclined with respect to the X-axis direction to be tapered in the Y-axis minus direction toward the X-axis plus direction. The tip of fifth portion 135b is formed in a rectangular shape in plan view. As described above, the boundary between notch 137b and fifth portion 135b includes inclined portion 1351b. Sixth portion 136b includes a part parallel to the X-axis direction, and a part (inclined portion 1361b) inclined with respect to the X-axis direction to be tapered in the Y-axis minus direction toward the X-axis minus direction. The tip of sixth portion 136b is formed in a rectangular shape in plan view. As described above, the boundary between notch 138b and sixth portion 136b includes inclined portion 1361b.

According to Embodiment 3, the boundaries between the first notches (notches 125b, 126b) and the first protrusions (second portion 122b and third portion 123b) include inclined portions 1221b, 1231b.

According to the above, since each of inclined portions 1221b, 1231b is included in the boundary between the first notch and the first protrusion portion, it is possible to prevent a steep decrease in the first protrusion that is the detection region. Therefore, it is possible to reduce a decrease in sensitivity caused by the first notch. This also applies to second sensor electrode 13b.

In Embodiment 3, for example, the case where a part of the side of second portion 122b in the Y-axis minus direction is inclined portion 1221b has been illustrated, but the entire side may be an inclined portion. This also applies to the third portion, the fifth portion, and the sixth portion.

Similarly to Embodiment 3, in FIG. 4 of Embodiment 1, a part of each of the sides of second portion 122 and third portion 123 in the Y-axis minus direction may be inclined. In this case, fifth portion 135 may be inclined to correspond to second portion 122, and sixth portion 136 may be inclined to correspond to third portion 123.

### Embodiment 4

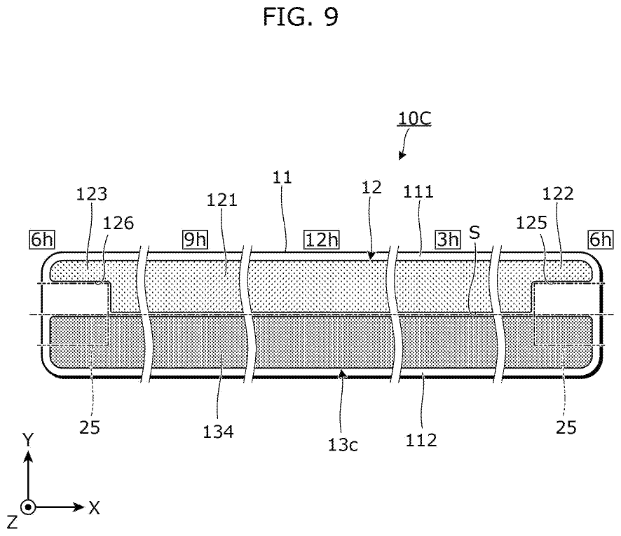

Next, electrode structure 10C according to Embodiment 4 will be described. FIG. 9 is a developed plan view illustrating electrode structure 10C according to Embodiment 4. FIG. 9 is a diagram corresponding to FIG. 4.

As illustrated in FIG. 9, in electrode structure 10C according to Embodiment 4, second sensor electrode 13c is different from second sensor electrode 13 according to Embodiment 1. In the following description, parts equivalent to those in Embodiment 1 are denoted by the same reference numerals, and the description thereof may be omitted.

Second sensor electrode 13c is rectangular in shape overall and covers substantially the entire second region 112. In second sensor electrode 13c, the corner in the X-axis plus direction and the Y-axis plus direction, and the corner in the X-axis minus direction and the Y-axis plus direction, are disposed within lower-limb facing portion 25. That is, only second sensor electrode 13c is disposed in lower-limb facing portion 25. Therefore, even when the driver's lower limb comes into contact with lower-limb facing portion 25, the lower limb comes into contact with at most one of first sensor electrode 12 or second sensor electrode 13c. That is, erroneous detection caused by the contact of the lower limb can be prevented.

### Embodiment 5

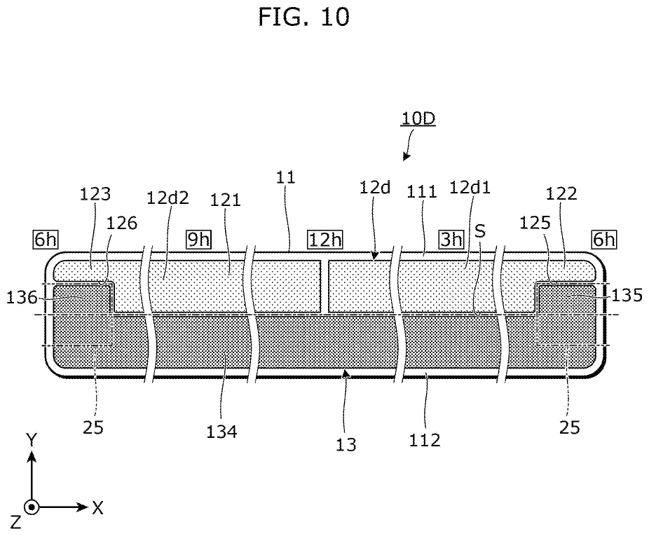

Next, electrode structure 10D according to Embodiment 5 will be described. FIG. 10 is a developed plan view illustrating electrode structure 10D according to Embodiment 5. FIG. 10 is a diagram corresponding to FIG. 4.

As illustrated in FIG. 10, electrode structure 10D according to Embodiment 5 is different from first sensor electrode 12 according to Embodiment 1 in that first sensor electrode 12d is divided into two in the X-axis direction. In the following description, parts equivalent to those in Embodiment 1 are denoted by the same reference numerals, and the description thereof may be omitted.

First sensor electrode 12d is divided at a central portion (12 o'clock position) in the X-axis direction, and includes first right electrode 12d1 in the X-axis plus direction and first left electrode 12d2 in the X-axis minus direction. First right electrode 12d1 and first left electrode 12d2 are electrically connected to control circuit 3 independently of each other. Control circuit 3 can detect whether the driver's hand has gripped the right half or the left half of rim 21 based on a signal from first right electrode 12d1 and a signal from first left electrode 12d2.

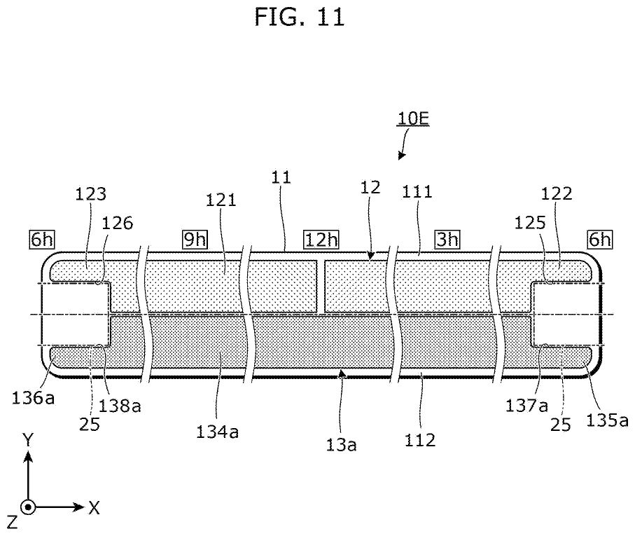

Note that FIG. 11 is a developed plan view illustrating electrode structure 10E according to another example of Embodiment 5. FIG. 11 is a diagram corresponding to FIG. 6. That is, electrode structure 10E illustrated in FIG. 11 divides first sensor electrode 12 of electrode structure 10A according to Embodiment 2 into two in the X-axis direction. Similarly to the configuration in FIG. 10, in this configuration as well, it is possible to detect whether the driver's hand has gripped the right half or the left half of rim 21.

### Embodiment 6

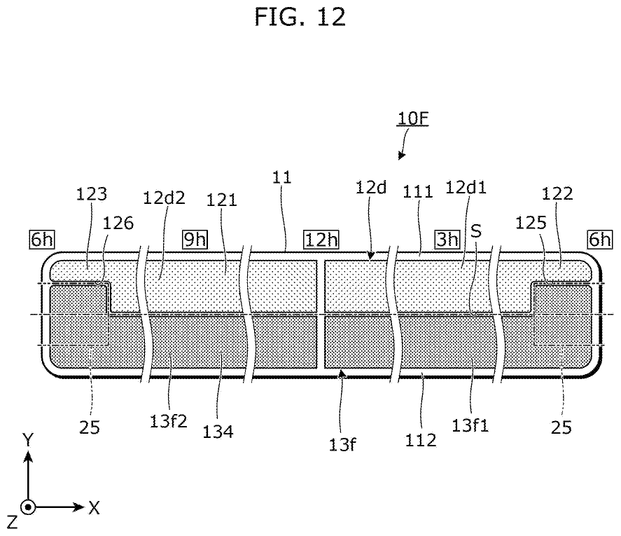

Next, electrode structure 10F according to Embodiment 6 will be described. FIG. 12 is a developed plan view illustrating electrode structure 10F according to Embodiment 6. FIG. 12 is a diagram corresponding to FIG. 10.

As illustrated in FIG. 12, electrode structure 10F according to Embodiment 6 is different from second sensor electrode 13 according to Embodiment 5 in that second sensor electrode 13f is divided into two in the X-axis direction. In the following description, parts equivalent to those in Embodiment 5 are denoted by the same reference numerals, and the description thereof may be omitted.

Second sensor electrode 13f is divided at a central portion (position at 12 o'clock) in the X-axis direction, and includes second right electrode 13f1 in the X-axis plus direction and second left electrode 13f2 in the X-axis minus direction. Second right electrode 13f1 and second left electrode 13f2 are electrically connected to control circuit 3 independently of each other. Control circuit 3 can determine that the driver is not correctly in contact with rim 21 based on a signal from first right electrode 12d1, a signal from first left electrode 12d2, a signal from second right electrode 13f1, and a signal from second left electrode 13f2. More specifically, when both the signal from first right electrode 12d1 and the signal from second left electrode 13f2 are signals from which the contact of the hand can be detected, or when both the signal from first left electrode 12d2 and the signal from second right electrode 13f1 are signals from which the contact of the hand can be detected, control circuit 3 determines that the driver is not correctly in contact with rim 21, and issues a warning.

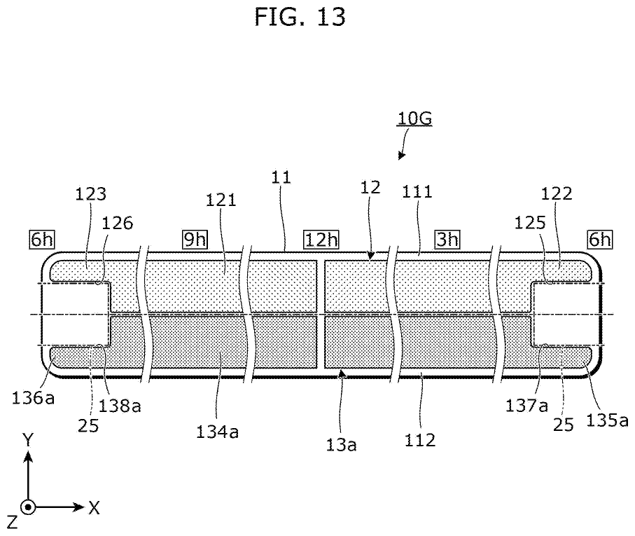

Note that FIG. 13 is a developed plan view illustrating electrode structure 10G according to another example of Embodiment 6. FIG. 13 is a diagram corresponding to FIG. 11. That is, electrode structure 10F illustrated in FIG. 13 divides first sensor electrode 12 of electrode structure 10E according to the other example of Embodiment 5 into two in the X-axis direction. Similarly to the configuration in FIG. 12, in this configuration as well, control circuit 3 determines a case where the driver is not correctly in contact with rim 21, and issues a warning.

### Embodiment 7

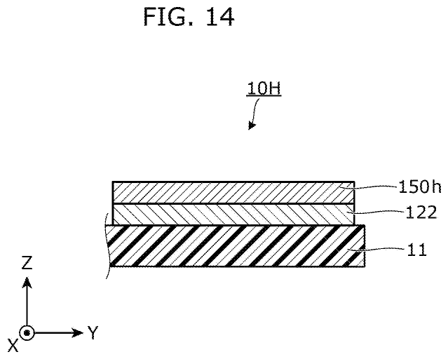

Next, electrode structure 10H according to Embodiment 7 will be described. FIG. 14 is a partial cross-sectional view of electrode structure 10F according to Embodiment 7. FIG. 14 is a cross-sectional view of a part including second portion 122 of electrode structure 10H.

As illustrated in FIG. 14, electrode structure 10H according to Embodiment 7 is different from electrode structure 10 according to Embodiment 1 in that first conductive layer 150h overlaid on second portion 122 is provided. In the following description, parts equivalent to those in Embodiment 1 are denoted by the same reference numerals, and the description thereof may be omitted.

First conductive layer 150h is overlaid on the entire second portion 122. First conductive layer 150h is made of a conductive tape, a conductive adhesive, or the like. As described above, since first conductive layer 150h is overlaid on second portion 122 that is an example of the first protrusion, the sensitivity can be increased by first conductive layer 150h. As a result, the sensitivity difference between first portion 121 and second portion 122 can be reduced even by second portion 122 that has a smaller area facing the hand compared to first portion 121 when the driver grips steering wheel 2. Accordingly, the detection accuracy can be further increased. Note that a first conductive layer overlaid on the other first protrusion and a first conductive layer overlaid on the second protrusion may be provided.

### Embodiment 8

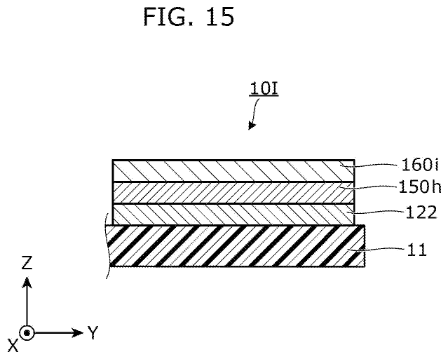

Next, electrode structure 10I according to Embodiment 8 will be described. FIG. 15 is a partial cross-sectional view of electrode structure 10I according to Embodiment 8. FIG. 15 is a cross-sectional view of a part including second portion 122 of electrode structure 10I. FIG. 15 is a diagram corresponding to FIG. 14.

As illustrated in FIG. 15, electrode structure 10I according to Embodiment 8 is different from electrode structure 10H according to Embodiment 7 in that second conductive layer 160i overlaid on first conductive layer 150h is provided. In the following description, parts equivalent to those in Embodiment 7 are denoted by the same reference numerals, and the description thereof may be omitted.

Second conductive layer 160i is overlaid on the entire first conductive layer 150h. Specifically, a conductive tape with adhesive layers on both sides is used as first conductive layer 150h, and second conductive layer 160i is attached to first conductive layer 150h. Second conductive layer 160i may have any form as long second conductive layer 160i has conductivity different from that of second portion 122 (first sensor electrode 12). In particular, second conductive layer 160i should have a conductivity higher than that of second portion 122. Since such second conductive layer 160i is overlaid on first conductive layer 150h, the sensitivity can be increased by second conductive layer 160i compared to the configuration illustrated in FIG. 14 where only first conductive layer 150h is overlaid on second portion 122. Therefore, the sensitivity difference from first portion 121 can be further reduced compared to the configuration in Embodiment 7, and hence, the detection accuracy can be further increased. Note that the second conductive layer may be overlaid on the first conductive layer overlaid on the other first protrusion, and may be overlaid on the first conductive layer overlaid on the second protrusion.

### Others

The electrode structure according to the present disclosure has been described above based on the embodiments, but the present disclosure is not limited to these embodiments. As long as the spirit of the present disclosure is not departed from, embodiments in which various modifications conceived by those skilled in the art are applied to the present embodiment and embodiments in which components in different embodiments are combined may be included in the scope of one or more aspects of the present disclosure.

### Note

The following techniques are disclosed by the description of the above embodiments and the like.

### (Technique 1)

An electrode structure to be wound around a rim of a steering wheel, the electrode structure including: a base material including a first region disposed on a front surface side of the rim and a second region disposed on a back surface side of the rim; a first sensor electrode disposed in the first region; and a second sensor electrode disposed in the second region, in which when the steering wheel is in a neutral position, in a lower-limb facing portion of the rim that faces a lower limb of a driver, neither the first sensor electrode nor the second sensor electrode is disposed, or only one of the first sensor electrode or the second sensor electrode is disposed.

### (Technique 2)

The electrode structure according to Technique 1, in which the first sensor electrode includes: a first notch included in a part corresponding to the lower-limb facing portion; and a first protrusion adjacent to the first notch in a circumferential direction in an axial cross-section of the rim.

### (Technique 3)

The electrode structure according to Technique 2, further including a first conductive layer overlaid on the first protrusion.

### (Technique 4)

The electrode structure according to Technique 3, further including a second conductive layer overlaid on the first conductive layer.

### (Technique 5)

The electrode structure according to any one of Techniques 2 to 4, in which a boundary between the first notch and the first protrusion includes an inclined portion.

### (Technique 6)

The electrode structure according to any one of Techniques 1 to 5, in which the first sensor electrode and the second sensor electrode are separated by a first length at a location corresponding to the lower-limb facing portion, and separated by a second length at a location corresponding to a portion other than the lower-limb facing portion, and the first length is longer than the second length.

### (Technique 7)

The electrode structure according to any one of Techniques 1 to 6, in which the second sensor electrode includes: a second notch included in a part corresponding to the lower-limb facing portion; and a second protrusion adjacent to the second notch in a circumferential direction in an axial cross-section of the rim.

### (Technique 8)

The electrode structure according to any one of Techniques 2 to 5, in which the second sensor electrode includes an extension extending into the first notch.

### (Technique 9)

The electrode structure according to any one of Techniques 1 to 8, in which the base material is wound around the rim to cause both ends of the base material to be adjacent to each other in the lower-limb facing portion.

### (Technique 10)

The electrode structure according to any one of Techniques 1 to 9, in which the first sensor electrode and the second sensor electrode each include a conductive sheet that increases in resistivity when stretched.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2023-066610 filed on Apr. 14, 2023.

### INDUSTRIAL APPLICABILITY

The electrode structure according to the present disclosure can be applied to a steering wheel of a moving body or the like.

1. An electrode structure to be wound around a rim of a steering wheel, the electrode structure comprising:
a base material including a first region disposed on a front surface side of the rim and a second region disposed on a back surface side of the rim;
a first sensor electrode disposed in the first region; and
a second sensor electrode disposed in the second region,
wherein when the steering wheel is in a neutral position, in a lower-limb facing portion of the rim that faces a lower limb of a driver, neither the first sensor electrode nor the second sensor electrode is disposed, or only one of the first sensor electrode or the second sensor electrode is disposed.

2. The electrode structure according to claim 1,
wherein the first sensor electrode includes:
a first notch included in a part corresponding to the lower-limb facing portion; and
a first protrusion adjacent to the first notch in a circumferential direction in an axial cross-section of the rim.

3. The electrode structure according to claim 2, further comprising:
a first conductive layer overlaid on the first protrusion.

4. The electrode structure according to claim 3, further comprising:
a second conductive layer overlaid on the first conductive layer.

5. The electrode structure according to claim 2,
wherein a boundary between the first notch and the first protrusion includes an inclined portion.

6. The electrode structure according to claim 1,
wherein the first sensor electrode and the second sensor electrode are separated by a first length at a location corresponding to the lower-limb facing portion, and separated by a second length at a location corresponding to a portion other than the lower-limb facing portion, and
the first length is longer than the second length.

7. The electrode structure according to claim 1,
wherein the second sensor electrode includes:
a second notch included in a part corresponding to the lower-limb facing portion; and
a second protrusion adjacent to the second notch in a circumferential direction in an axial cross-section of the rim.

8. The electrode structure according to claim 2,
wherein the second sensor electrode includes an extension extending into the first notch.

9. The electrode structure according to claim 1,
wherein the base material is wound around the rim to cause both ends of the base material to be adjacent to each other in the lower-limb facing portion.

10. The electrode structure according to claim 1,
wherein the first sensor electrode and the second sensor electrode each include a conductive sheet that increases in resistivity when stretched.
